(19) United States
(12) Patent Application Publication
(10) Pub. No.: US 2015/0326664 A1
(43) Pub. Date: Nov. 12, 2015

(54) SYSTEM AND METHOD FOR MANAGING DATA TRANSACTIONS BETWEEN APPLICATIONS

(71) Applicant: Plains Mobile Inc., Linton, ND (US)

(72) Inventor: Jon A. Richter, Linton, ND (US)

(21) Appl. No.: 14/706,574

(22) Filed: May 7, 2015

Related U.S. Application Data
(60) Provisional application No. 61/991,029, filed on May 9, 2014.

(51) Int. Cl. H04L 29/08; G06Q 10/06

(52) U.S. Cl. CPC H04L 67/1095; G06Q 10/06; H04L 67/06

(57) ABSTRACT

A method and system for managing data transactions having a transaction exchange server. The system includes a first listener modular program instance installed at a source system that supports an application utilizing a first application-specific file format. The system includes a second listener modular program instance installed at a destination system that supports an application utilizing a second application-specific file format different from the first application-specific file format. The first listener modular program instance transforms data from the first application-specific file format into data in a common transaction description format. The first listener modular program instance communicates the data in the common transaction description format to the transaction exchange server. The second listener modular program instance initiates a call to receive the data. The second listener modular program instance transforms the received data from the common transaction description format into the second application-specific file format.

### CROSS-REFERENCE TO RELATED APPLICATION(S)

This application claims priority to, and the benefit of, co-pending U.S. Provisional Application 61/991,029, filed May 9, 2014, for all subject matter common to both applications. The disclosure of said provisional application is hereby incorporated by reference in its entirety.

### FIELD OF THE INVENTION

The present invention relates to managing data transactions between applications, and more particularly to managing data transactions utilizing a common transaction description format for communicating between at least two applications that use different application-specific file formats.

### BACKGROUND OF THE INVENTION

In conventional transaction systems, businesses integrate by transforming data between concrete data models having application-specific file formats. Many of these conventional transaction systems use middleware to transform data between applications. This type of architecture creates a significant burden in the ability to share data between applications and businesses.

In one example, enterprise resource planning (ERP) is a business process management software that is used by an organization to manage a business. The ERP software or system can integrate different parts of an operation, such as product planning, development, manufacturing, sales, regulatory, etc. ERP systems can use an Application Programming Interface (API) to integrate data that is expected to have data formatted to match that of a particular ERP system. However, the ability to easily share data between applications having different application-specific file formats has not been adequately addressed or solved by ERP systems due to its limitations.

### SUMMARY

There is a particular need for integration of data between different business areas and software applications from those areas having different application-specific file formats. There is a need to enable businesses to easily share transactions between their own internally utilized applications and also share transactions with business partners and customers outside of the business organization and systems. There is a need to integrate data between different applications using different application-specific file formats, especially with the growth of mobile devices.

The present invention system overcomes the challenge of a business integrating transactions between applications, divisions, and customers. The present invention removes the requirement of having middleware to transform data, which requires developer involvement and includes different security and privacy risks.

The present invention provides a common meaning to transactions between multiple systems. The present invention is directed to a common transaction description format which enables additional opportunity for integrated application development such as through the internet and including cloud based systems and interactions or transactions leveraging cloud based systems. The present invention particularly allows for a transactional document to be turned into a transaction description format (e.g., abstract transaction). The present invention enables applications and businesses to more easily and securely share transactions.

In accordance with an embodiment of the present invention, a system for managing data transactions includes a transaction exchange server. The system also includes a first listener modular program instance installed at a source system. The source system supports an application that utilizes a first application-specific file format. The system includes a second listener modular program instance installed at a destination system. The destination system supports an application that utilizes a second application-specific file format which is a different file format from the first application-specific file format. The first listener modular program instance transforms data supplied by, and stored at, the source system from the first application-specific file format, storable and readable by the application that utilizes the first application-specific file format, into data in a common transaction description format. The first listener modular program instance communicates the data in the common transaction description format to the transaction exchange server, which stores the data in the common transaction description format as an active transaction until the destination system initiates a call to receive the data. The second listener modular program instance at the destination system initiates the call to receive the data. The transaction exchange server copies the data and communicates the copied data in the common transaction description format to the destination system. The second listener modular program instance at the destination system confirms receipt of the copied data and transforms the copied data from the common transaction description format into the second application-specific file format storable and readable by the application that utilizes the second application-specific file format at the destination system. The transaction exchange server stores the data as a historic transaction after the second listener modular program instance at the destination system confirms receipt of the copied data.

In accordance with aspects of the present invention, the first listener modular program instance installed at the source system is authenticated to the transaction exchange server. In another aspect, the second listener modular program instance installed at the destination system is authenticated to the transaction exchange server.

In accordance with aspects of the present invention, the first listener modular program may utilize Structured Query Language to transform the data supplied by, and stored at, the source system from the first application-specific file format into the data in a common transaction description format. In accordance with one aspect, the second listener modular program instance at the destination system may utilize Structured Query Language to transform the data in the common transaction description format into data in the second application-specific file format. In one example, the listener modular program instances 18, 24 can be bundled with a common application but in other examples it is the developers' discretion on how to manage their common transaction description formatted data.

In accordance with aspects of the present invention, the first application-specific file format and the second application specific-file format includes proprietary formats, non-proprietary formats, open source formats, or open-standard formats. The first application-specific file format and the second application specific-file format can include text file formats, graphic file formats, data file formats, spreadsheet file formats, word processor file formats, video and audio file formats, markup language formats, archive formats, compressed formats, computer-aided formats, database formats, webpage formats, mobile device formats, windows file formats, or object file formats.

In accordance with one aspect of the present invention, the first listener modular program instance and the second listener modular program instance include an interpretation layer which builds an integration infrastructure based on a unique definition of an interface of the application utilizing either the first application-specific file format or the second application specific-file format.

In accordance with aspects of the present invention, the common transaction description format includes a listener identification character value corresponding with either the first listener modular program instance or the second listener modular program instance. The common transaction description format can include a unique transaction index value corresponding with either the first application-specific file format or the second application specific-file format. The common transaction description format can include a sender identification key corresponding with the application utilizing the first application-specific file format. The common transaction description format can include a receiver identification key corresponding with the application utilizing the second application-specific file format. The common transaction description format can include metadata having at least one meta string and at least one meta value.

In accordance with an embodiment of the present invention, a computer-implemented method of communicating data transactions between applications, the method includes an application of a source system supplying data in a first application-specific file format. A first listener modular program instance of the source system transforms the data, supplied by the source system, from the first application-specific file format into data in a common transaction description format. The first listener modular program instance communicates the data in the common transaction description format to a transaction exchange server. The transaction exchange server stores the data in the common transaction description format as an active transaction until a destination system initiates a call to receive the data. A second listener modular program instance at the destination system initiates a call to the transaction exchange server to receive the data. The transaction exchange server communicates the data to the second listener modular program instance at the destination system in common transaction description format. The second listener modular program instance at the destination system receives the data in the common transaction description format from the transaction exchange server. An application of the destination system utilizes a second application-specific file format which is a different file format from the first application-specific file format.

In accordance with one aspect of the present invention, the transaction exchange server stores the data as a historic transaction after the second listener modular program instance at the destination system confirms receipt of the data.

In accordance with an embodiment of the present invention, a computer-implemented method of communicating data transactions between applications, the method includes a transaction exchange server receiving data in a common transaction description format from a source system. The transaction exchange server stores the data in the common transaction description format as an active transaction until a destination system initiates a call to receive the data. A listener modular program instance at the destination system initiates a call to the transaction exchange server to receive the data. The transaction exchange server communicates the data in the common transaction description format to the destination system. A listener modular program instance of the destination system receives the data in the common transaction description format from the transaction exchange server. The second listener modular program instance of the destination system transforms the data in the common transaction description format into an application-specific file format storable and readable by an application at the destination system.

In accordance with an embodiment of the present invention, a listener system provides universal communication to an application. The listener system includes a sending module configured to direct data in a common transaction description format from an application to a transaction exchange server. The listener system includes a receiving module configured to obtain data in the common transaction description format from the transaction exchange server. The listener system includes a transformation module configured to transform data from at least one application-specific file format into data in the common transaction description format and transform data from the common transaction description format into the at least one application-specific file format.

In accordance with one aspect of the present invention, the listener system includes a posting module configured to incorporate new data in at least one application-specific file format with previously stored data in at least one application-specific file at the application.

### BRIEF DESCRIPTION OF THE FIGURES

These and other characteristics of the present invention will be more fully understood by reference to the following detailed description in conjunction with the attached drawings, in which:

FIG. 1 is an illustrative diagram of a conventional system for managing data transactions and an example embodiment of a present invention system for managing data transactions;

FIG. 2 is an illustrative diagram of a system for managing data transactions, according an embodiment of the present invention;

FIG. 3 is an illustrative diagram of a listener system for providing universal communication to an application, according to an embodiment of the present invention;

FIG. 4 is a flow chart illustrating a process for communicating data transactions between applications, according to an embodiment of the present invention;

FIG. 5 is an illustrative diagram of a system for managing data transactions, according to one aspect of the present invention;

FIG. 6 is a computer display of a data transaction stored within the system, according to one aspect of the present invention; and

FIG. 7 is a schematic view of a computing device or system, suitable for implementing the system and method of the present invention.

### DETAILED DESCRIPTION

The system of the present invention enables applications and businesses to share transactions more efficiently and effectively. A transaction pipeline is enabled for businesses where transaction sharing can be enabled between partners and customers. One of the key aspects to the present invention is the ability to take any transactional document and transform it into a common transaction description format (e.g., abstract transaction) so that it can be universally read by applications and systems at the destination end of a data transaction. Accordingly, the present invention provides an improvement to the technical area of data transaction systems. In particular, the present invention provides an improvement for data transactions carried out by businesses using various different applications with their own distinct data file formats. This improvement in technology also creates an improvement to business operations, enabling business data transactions to be performed more efficiently and effectively over a variety of different devices (e.g., devices using different application specific file formats). Moreover, the development of new technologies and devices with different data file formats has created a need for the functionality provided by the present invention. Specifically, the development of, and expanded use of, mobile computing devices and business oriented applications on mobile devices has created data transaction systems involving multiple different application specific file formats for the same data. These multiple different application specific file formats make it very difficult for data to be shared amongst different applications using different file format structures. For example, a mobile application on a smartphone can have a particular application specific file format for business data, while software on a computer at an office can have a second different application specific file format or die same business data, in such a way that the mobile application cannot read data contained in files from the software on a computer, and vice versa. Even different mobile devices can use different application specific file formats (e.g., Android™, Apple's iOS). Accordingly, the development of new technologies and means for accessing and sharing data between different applications using different file formats has created a problem requiring a solution to efficiently perform data transactions between devices using different application specific file formats (e.g., the need solved by the present invention).

An illustrative embodiment of the present invention relates to a system and method for managing data transactions. The system includes a transaction exchange server that functions in conjunction with a common transaction description format providing an architecture where data is transformed and shared between applications and businesses in a secure manner. This provides integration of data between businesses and applications which has not been available in conventional systems. The system can include a listener modular program instance (e.g., Listener Snap-In) that has a transformation tool for transforming data to or from an application-specific file format to or from data in a common transaction description format. The transaction exchange server along with the common transaction description (CTD) format provides an architecture where any transactional data can be interpreted, and which allows the transaction exchange server to display CTD format data in readable format without developer or user intervention. The system can provide the ability to quickly deploy integrated mobile applications and cloud applications. Also, the present invention features the ability to view and validate transactions via a transaction exchange server which is an architectural improvement compared with convention systems.

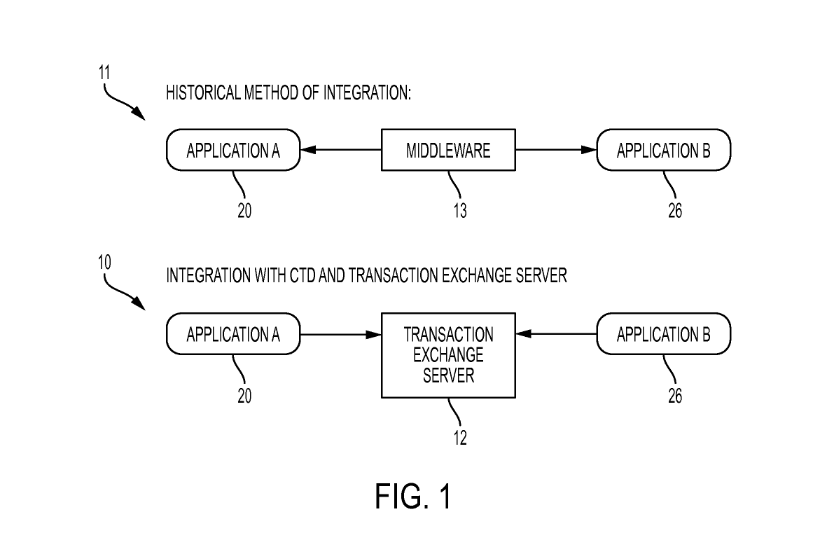

FIGS. 1 through 7, wherein like parts are designated by like reference numerals throughout, illustrate a system and method for managing data transactions according to the present invention. Although the present invention will be described with reference to the figures, it should be understood that many alternative forms can embody the present invention. One of skill in the art will additionally appreciate different ways to alter the parameters disclosed, such as the size, shape, or type of elements, in a manner still in keeping with the spirit and scope of the present invention.

FIG. 1 is an illustrative diagram (upper figure) of a conventional system 11 for managing data transactions and an example embodiment (lower figure) of a present invention system 10 for managing data transactions. The system 10 of the present invention includes applications (Application A 20 and Application B 26) managing the sending and receiving of transaction messages, while the historical method of the conventional system 11 utilizes middleware 13 to manage transaction sharing. With the historical method, the middleware 13 manages communication to either Application A 20 or Application B 26. With the system 10 of the present invention, Application A 20 and Application B 26 handle or control the communication to and from a transaction exchange server 12 to send and receive messages. With the conventional system 11, security is a vital concern as the applications 20, 26 need to open up security to an outside gateway that is initiated from another location on the internet. With the system 10 of the present invention, such concerns are reduced or eliminated.

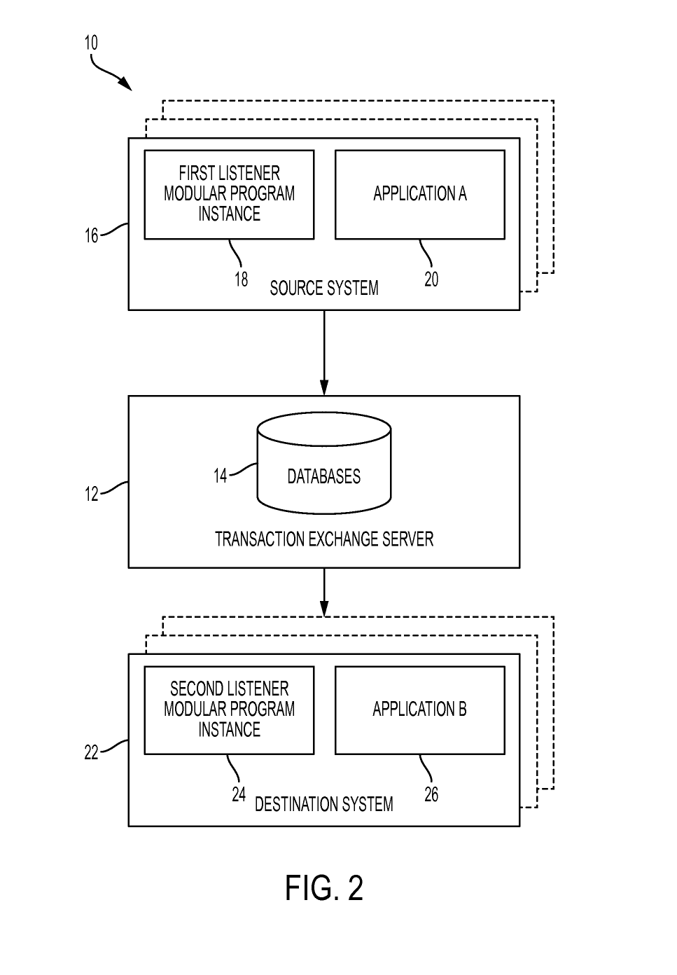

FIG. 2 depicts a system 10 for managing data transactions. The system 10 for managing data transactions includes a transaction exchange server 12 having databases 14 for storing data. The system 10 includes a source system 16 that has an installed first listener modular program instance 18 and application A 20. The source system 16 supports an application A 20 that utilizes a first application-specific file format. The system 10 includes a destination system 22 that has an installed second listener modular program instance 24 and application B 26. The destination system 22 supports an application B 26 that utilizes a second application-specific file format, which is a different file format from the first application-specific file format. The first listener modular program instance 18 transforms data supplied by, and stored at, the source system 16 from the first application-specific file format, storable and readable by application A 20, into data in a common transaction description (CTD) format. The first listener modular program instance 18 communicates the data in the CTD format to the transaction exchange server 12, which stores the data in the CTD format as an active transaction until the destination system 22 initiates a call to receive the data. The second listener modular program instance 24 at the destination system 22 initiates the call to receive the data. The transaction exchange server 12 copies the data and communicates the copied data in the CTD format to the destination system 22. The second listener modular program instance 24 at the destination system 22 confirms receipt of the copied data and transforms the copied data from the CTD format into the second application-specific file format storable and readable by application B 26. The transaction exchange server 12 stores the data as a historic transaction after the second listener modular program instance 24 confirms receipt of the copied data. In one example, the first listener modular program instance 18 installed at the source system 16 is initially authenticated to the transaction exchange server 12. In another example, the second listener modular program instance 24 installed at the destination system 22 is initially authenticated to the transaction exchange server 12.

In one example, the first listener modular program instance 18 utilizes Structured Query Language (SQL) to transform the data supplied by, and stored at, the source system 16 from the first application-specific file format into the data in a CTD format. In another example, the second listener modular program instance 24 utilizes SQL to transform the data in the CTD format into data in the second application-specific file format. One of skill in the art understands the underling process for utilizing SQL to transform data into a different format (such as CTD format), such that no further description is required. Known variations of such a process are likewise appreciated by one of skill in the art in order to accomplish the overall goal of the present invention. In one example, the listener modular program instances 18, 24 can be bundled with a common application but in other examples it is the developers' discretion on how to manage their common transaction description formatted data.

The first listener modular program instance 18 and second listener modular program instance 24 can function as a snap-in feature (i.e., “The Listener”) which is utilized by applications to manage the integration and transformation of CTD data from a transaction exchange server 12. If the application does not have “The Listener” snap-in, it is up to the application to define their own method of handling data or messages. The Listener can utilize Structured Query Language views to transform CTD transactions to the application-specific file format (e.g., concrete format) defined by each application. Furthermore, the Listener has a built-in interpretation layer which can build the integration infrastructure based on the unique definition of an Application Programming interface (API). This building of an interpretation layer (e.g., The Listener) which automatically builds the infrastructure to use Structured Query Language can be particularly utilized to transform the CTD format to the application-specific file form. In one example, either the first listener modular program instance 18 and/or the second listener modular program instance 24 includes an interpretation layer which builds an integration infrastructure based on a unique definition of an interface of the application utilizing either the first application-specific file format or the second application specific-file format.

The application-specific file format (whether first or second) can include proprietary formats, non-proprietary formats, open source formats, or open-standard formats. In another example, the application-specific file format can include text file formats, graphic file formats, data file formats, spreadsheet file formats, word processor file formats, video and audio file formats, markup language formats, archive formats, compressed formats, computer-aided formats, database formats, webpage formats, mobile device formats, windows file formats, or object file formats. A person having skill in the art would appreciate other combinations of application-specific file formats not included in these lists as known in the field.

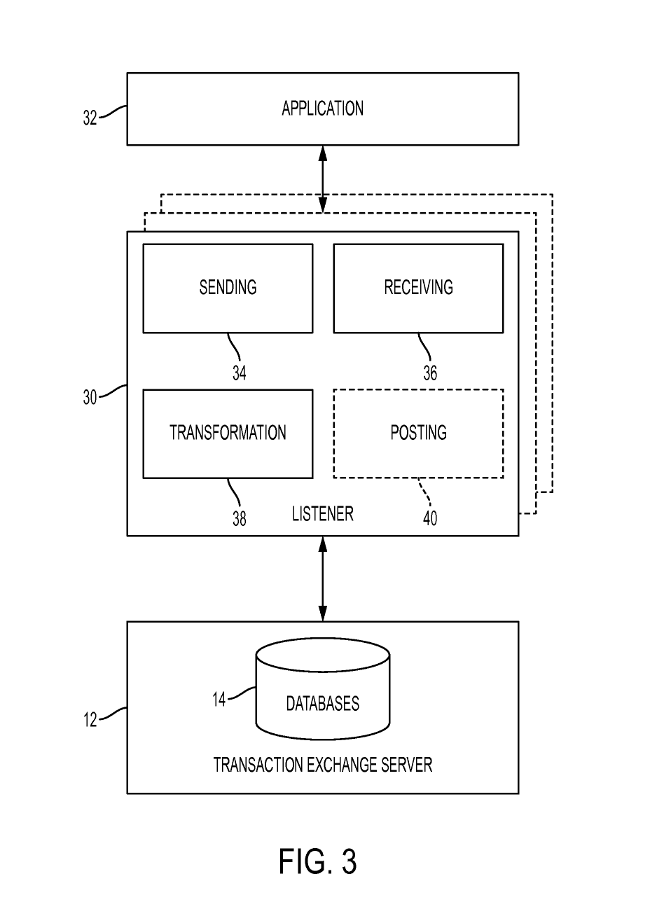

FIG. 3 depicts an example embodiment of a listener system 30 that can provide universal communication to an application 32 (e.g., application A 20 or application B 26). The listener system 30 includes a sending module 34 which directs data in a CTD format from the application 32 to a transaction exchange server 12. The listener system 30 includes a receiving module 36 that obtains data in the CTD format from the transaction exchange server 12. The listener system 30 includes a transformation module 38 which transforms data from an application-specific file format (storable and readable by the application 32) into data in the CTD format. This transformation module 38 can also transform data from the CTD format into data in the application-specific file format (storable and readable by the application 32) that can be processed by one or more application(s).

In an optional example, the listener system 30 can include a posting module 40 that incorporates new data in the application-specific file format with previously stored data in the application 32. The posting module 40 integrates the new data (e.g., data directed to application B 26 of the destination system 22) with previously stored data in the application-specific file format which is supported by the application 32. For example, the posting module 40 is an interpreted code base that binds the data in CTD format and the defined transformation to an application-specific file format (e.g., application-specific file format of application B 26). The abstract nature of the CTD format provides for the creation of the posting module 40. In particular, the posting module 40 would not be manufactured in a timely manner (through interpretation) without the use of the CTD format (i.e., abstract data layer).

In use, the listener system 30 (i.e., listener modular program instances 18, 24) can be a Listener snap-in or add-on solution to applications 32 (e.g., Application A 20 of source system 16 and Application B 26 of destination system 22) as shown in FIG. 2. In this example, the listener system 30 provides transformation of data (in application-specific file format to CTD format or in CTD format to application-specific file format) at the application 32 (either Application A 20 or Application B 26). In another example, the listener system 30 can be a Listener snap-in or add-on solution to the transaction exchange server 12. In this transaction exchange server example, data in an application-specific file format is directly received at the transaction exchange server 12 where it is converted by the listener system 30 to CTD format prior to storage (i.e., data is converted to CTD format at the transaction exchange server 12). Also, with this transaction exchange server example, the listener system 30 is configured to convert data in CTD format to data in a variety of application-specific file formats in response to a request of receipt by an application 32 (i.e., Application B 26 of destination system 22). As shown in FIG. 3, the listener system 30 can be a separate entity or module from the applications 32 (i.e., Application A 20 and Application B 26) and the transaction exchange server 12. For example, the listener system 30 can be a separate device or a Listener add-on solution to a separate server that communicates between the applications 32 and the transaction exchange server 12. In this separate listener example, the listener system 30 functions in between all the applications 32 and the transaction exchange server 12 for all transformation purposes (i.e., configured to transform data in application-specific file formats to CTD format or transform data in CTD format to application-specific file formats). Other configurations of the listener system 30 with respect to an application 32 and transaction exchange server 12 may be appreciated by one of skill in the art while staying within scope of the present invention.

The transformation module 38 can utilize SQL to transform the data either from a CTD format to application-specific file format or application-specific file format to CTD format. For example, the transformation module 38 can use a profile that includes a database object containing a set of application-specific file format statements and their transformations or transformation errors. This profile can be used to review, approve, and/or modify transformations. The transformation module 38 can be used with one or more application profiles for one or more applications 32. For example, multiple applications 32 can share transformed queries or profiles can be exported between applications 32.

In use, for example, the transformation module 38 converts the data in an application-specific file format directly into CTD format. This allows for the transformation module 38 to utilize the extensive capability of SQL in transforming data from the CTD format to a destination application-specific file format. For example, text file parsers may be used to automatically transform any application-specific file format to CTD format. The nature of the presently described CTD format allows for the interpretation and transformation of any application-specific file format (e.g., concrete data object model) to the CTD format (e.g., CTD abstract data model).

In another example, the transformation module 38 can include a group of Perl sub-modules that can manipulate structured data definitions such as converting CTD format SQL table definitions into application-specific file format formats (e.g., SQL, documentation, diagrams, XML, etc.), Instead of SQL, parsers can be used for other structured data formats such as Excel spreadsheets and delimited text files. Thus, in this example, the software code can be separated into producers and parsers with an object mode between (i.e., any parser can be combined with any producer to plug into custom parsers or producers or manipulate parsed data through an object model). In another example, the transformation module 38 can convert among a variety of syntax and visualizations of schemas, convert non-RDBMS (relational database management system) files to SQL, serialize parsed schemas, and create documentation (i.e., basically replace a sequence of characters in a string for one format with another sequence of characters of a different format).

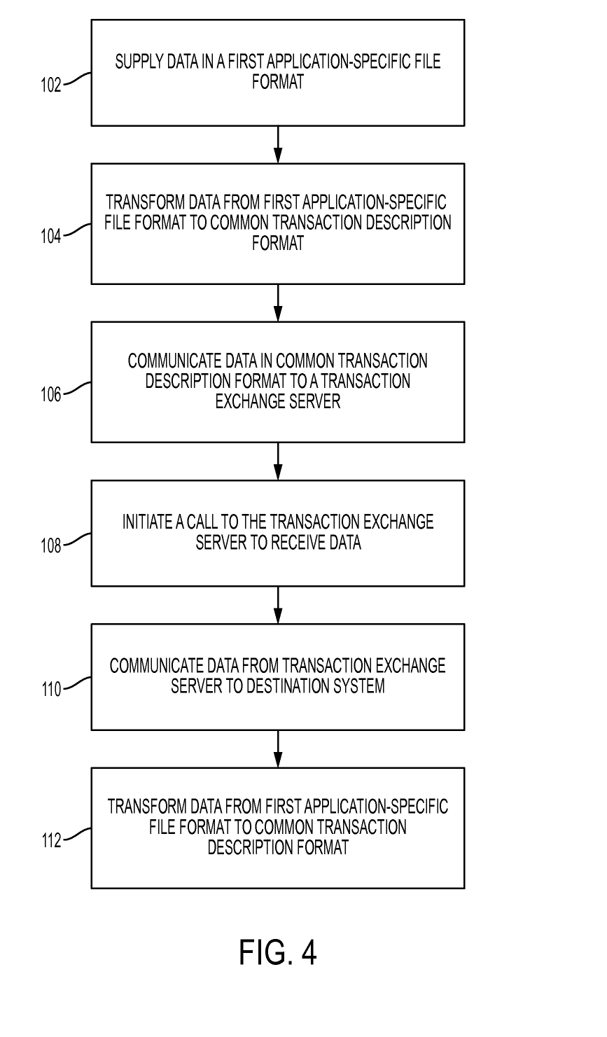

FIG. 4 depicts the process for communicating data transactions between applications 20, 26 (i.e. life of data in CTD format between two different application-specific file formats). In step 102, an application A 20 of a source system 16 supplies data in a first application-specific file format. A first listener modular program instance 18 of the source system 16 transforms the data, supplied by the source system 16, from the first application-specific file format into data in a CTD format (step 104). In step 106, the first listener modular program instance 18 communicates the data in the CTD format to a transaction exchange server 12. The transaction exchange server 12 stores this data in the CTD format as an active transaction until a destination system 22 initiates a call to receive the data. In step 108, the second listener modular program instance 24 at the destination system 22 initiates a call to the transaction exchange server 12 to receive the data. The transaction exchange server 12 communicates the data to the second listener modular program instance 24 at the destination system 22 in CTD format (step 110). The second listener modular program instance 24 at the destination system 22 receives the data in the CTD format from the transaction exchange server 12. In step 112, the second listener modular program instance 24 transforms the data in the CTD format into an application-specific file format storable and readable by an application B 26 at the destination system 22. In one example, the transaction exchange server 12 can further store transaction data as a historic transaction after the second listener modular program instance 24 confirms receipt of the data as part of step 110.

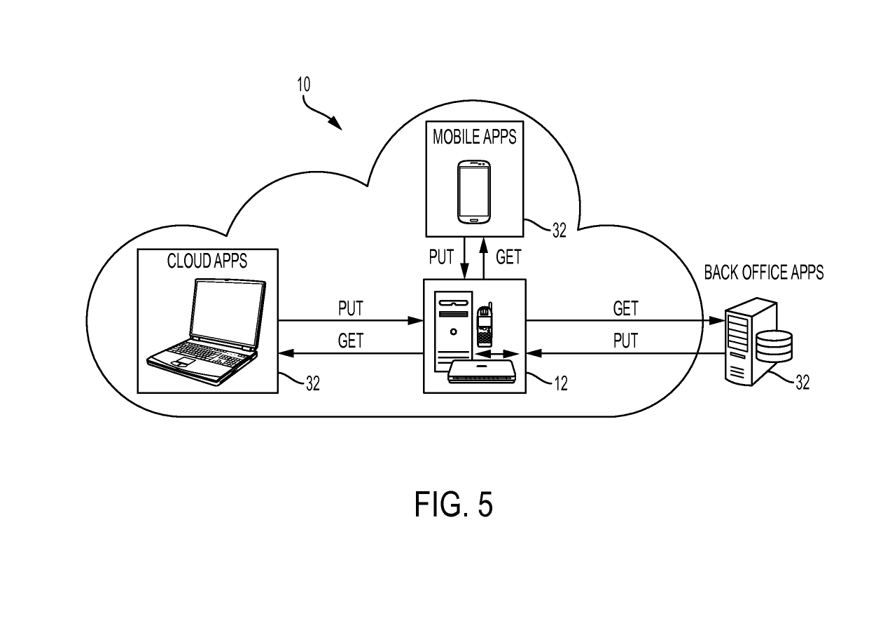

FIG. 5 depicts the system 10 managing data transactions between various types of applications 32. For example, the application 32 can be a cloud application, mobile application, or back office application. Example cloud applications can include Microsoft Dynamics® customer relationship management (CRM), Salesforce®, Plains Mobile 2020™, customized software, etc. Example mobile applications can include Plains Mobile 2020™, customized solutions, etc. Example back office applications can include Microsoft Dynamics® GP, Microsoft Dynamics® Ax, Sage ERP X3®, customized software, etc. As described above, these different applications 32 (i.e., cloud application, mobile application, and back office application) communicate via the transaction exchange server 12 (e.g., transaction exchange web service) to send and receive data (e.g., messages) in CTD format. The listener modular program instance 18, 24 (e.g., Listener Service Snap-In) resides in these applications 32 to manage the communication to and from the transaction exchange server 12 and the transformation of CTD format to and from an application-specific file format recognized by the application 32. This provides significant security improvement compared with conventional systems 11 as applications no longer need to open up a security gateway as required for middleware solutions. The transaction exchange server 12 can confirm receipt of CTD transactions from senders and receivers based on a security context. After the data is successfully received, the data (e.g., messages) stored in the transaction exchange server 12 can be moved and stored in a history database 14. This system 10 enables applications 32 (e.g., mobile applications) to send data (e.g., messages) to the transaction exchange server 12 asynchronously based on connection availability. Thus, the transaction exchange server 12 acts as a hub for businesses to send and receive their CTD transactions (i.e., enabling management of data or transactional messages). For example, client side applications can each individually contact the transaction exchange server 12 to send and retrieve data or transaction messages. In one example, the transaction exchange server 12 functions via cloud computing (i.e., cloud gateway service).

The system 10 in use according to an example implementation has the following main stages: Put Message, Transaction Exchange Server, Get Message, Transformation, and API Post. The Put Message stage (as shown in FIG. 5) includes initiation of a data transaction by a sending application 32 (e.g., mobile, cloud, or back office application). This causes data (e.g., message in CTD format) to be sent to the transaction exchange server 12 from the sending application 32. A confirmation response from the transaction exchange server 12 is sent back to the sending application 32. At the transaction exchange server stage, the CTD transactions are stored in the transaction exchange server 12 with respect to the particular sender and receiver information of the data. When the data (e.g., CTD messages) is retrieved by a receiving application 32, the retrieved data is optionally stored in the history database 14 of the transaction exchange server 12. The Get Message stage, as shown in FIG. 5, includes data (e.g., messages) being received by a receiving application 32. Initially, the transaction exchange server 12 confirms if the receiving application 32 is the proper “receiver” then the transaction exchange server 12 directs the data to the receiving application 32. The data (e.g., message) is received by the application in CTD format and stored in a listener modular program instance 18, 24 (e.g., Listener Module). At the Transformation stage, a transformation Query view puts (i.e., transforms) the CTD data or records into an application-specific file format associated with the API of the receiving application 32 (e.g., mobile, cloud, or back office application). During the API Post stage, a manual or automated process posts the data transactions to an application database utilizing dynamic view for easy transformation and visual validation. Audit trail data can be stored in history for transactions in the application 32. The applications 32 that are listener enabled can automatically build API interpretation of business objects.

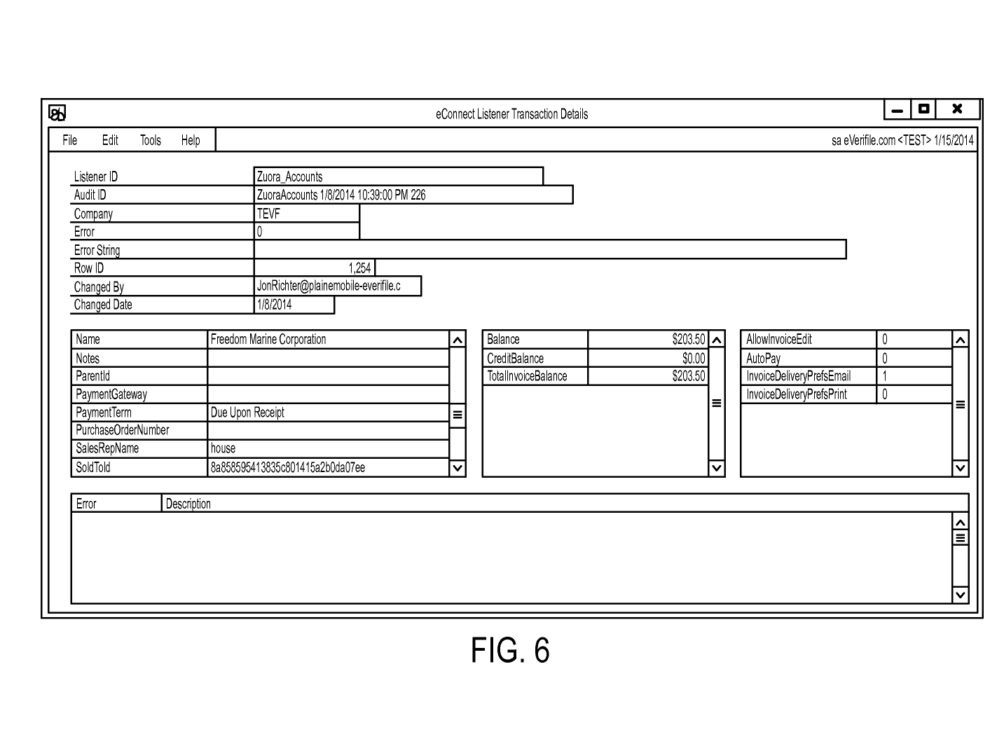

In accordance with one example embodiment, business users utilizing an application 32 can visit a website that interfaces with the transaction exchange server 12 where all data (e.g., messages) associated with their business can be displayed. This display feature is particularly useful in testing and transaction management. Furthermore, this use of the CTD format provides a mechanism for all data or transactions stored in the transaction exchange server 12 to be displayed in any desired useful way at the transaction exchange server 12. FIG. 6 illustrates this feature of the transaction exchange server 12. In particular, FIG. 6 depicts a computer display or screen shot of a data transaction in a CTD format that has been accessed from the transaction exchange server 12.

The CTD format is defined in a way that allows developers to efficiently convert their existing data transactions to data in a CTD format. The CTD format can have a layer of abstraction that defines any type of business transaction. This format assumes that every transaction consists of a combination of Strings, Numbers, Integers, and Images. By building this type of abstract definition (i.e., CTD format), every transaction can conform to various types of applications 32 allowing for these applications 32 to send and receive any transaction that is in the CTD format.

Thus, this CTD format provides a universal language allowing for the system 10 to function between different applications that deal with distinct application-specific file formats. The CTD format can have a number of components or elements that enable it to act as a universal language between applications through a transaction exchange server 12. For example, the CTD format can include a listener identification character value (ListenerID) that corresponds with a listener modular program instance 18, 24. For example, data in CTD format that is sent from the first listener modular program instance 18 of the source system 16 to the second listener modular program instance 24 at the destination system 22 can be labeled with a listener identification character value (ListenerID) for the first listener modular program instance 18 and a listener identification character value (ListenerID) for the second listener modular program instance 24. In one example, the receiver application (i.e., Application B 26) can initiate a call to the transaction exchange server 12 to gather certain transactions having a specific listener identification character value (e.g., corresponding with the listener modular program instance of the receiver application) or can initiate a call to get all CTD data transactions with the specific listener identification character value.

In a further example, filters may be provided by the receiver application (i.e., Application B 26) for all elements within the CTD data transaction. The filters capture only CTD data transactions having particular attributes based on set filtered search criteria. For example, the filters may be configured to capture only CTD data transactions that deal with accounting or only CTD data transactions from a particular sender. This filter functionality allows for multiple listener modular program instances 24 (e.g., all within Application B 26) that have one listener identification character value (e.g., receiver key) to communicate smoothly with the transaction exchange server 12. This filter functionality also enables the transaction exchange server 12 to manage multiple transactions and define them in the CTD format for specialized receipt by receiving applications searching for certain categories of data. Thus, for example, the listener identification character value is utilized to group CTD data transactions into certain types of transactions that the receiver application can utilize as part of a query filter search.

The transaction exchange server 12 can authenticate a data request based on the listener identification character value (e.g., receiver identity and security key) and supply the CTD data transactions after this authentication (e.g., based on the specific filtered query request). Also, in one example, the type of conversion (e.g., CTD format to application-specific file format of Application A 20) can be determined by the listener identification character value (i.e., corresponding with a specific application or an application-specific file format). Thus, for example, the listener identification character value is utilized by the listener modular program instance 18, 24 for selecting the proper conversion process needed to transform data in CTD format to an application-specific file format. Furthermore, the listener identification character value may be used to define which SQL transformation view to apply to a CTD data transaction in order to generate the application-specific file format of the destination application.

In one example, a receiver application (i.e., Application B 26) can have unlimited listener identification character values corresponding with one listener modular program instance 24 or multiple listener modular program instances 24 at the destination system 22. In this example, one or more transformation map views may be linked to each of the listener identification character values along with multiple application-specific file formats (i.e., application specific data objects).

In another example, the CTD format can include a unique transaction index value (AuditID). In particular, data in CTD format can be labeled with a unique transaction index value correlating with the grouping of transactions for application A 20 and/or application B 26. For example, as the data is initially converted by the first listener modular program instance 18 into CTD format, the CTD format is labeled with the unique transaction index value correlating with the sending application's (Application A 20) specific transaction group. Within a table format example, the unique transaction index value can be utilized to group rows (where each row is a data transaction) together as multiple rows could make up one complete group of CTD data transactions. A complete group of data transactions may be comprised of one or more rows data transactions in CTD format each bound to one another by similar values. For example, these values may include a receiver identification key, listener identification character value, and unique transaction index value.

The CTD format can include a sender identification key and a receiver identification key. As described above, this can be utilized by the transaction exchange server 12 in confirming that a particular application 32 is the proper receiver, for example. The sender identification key corresponds with the application A 20 of a source system 16. The receiver identification key corresponds with application B 26 of a destination system 20. Utilizing this CTD format, the integration architecture is configured to allow applications 32 to periodically connect to the transaction exchange server 12 (i.e., messaging gateway) to receive all the transaction messages that match their receiver identification key along with additional query filters as needed. These query filters can support the process of searching for particular CTD data transactions based on certain data attributes (e.g., AuditID) embedded within the CTD data transactions. Business applications 32 that need to send messages to another business application can use this CTD format by generating messages with a sender identification key and receiver identification key which is sent to the transaction exchange server 12 for delivery. Thus, the transaction exchange server 12 can save and organize the CTD transactional data in storage areas for senders and receivers based on the sender identification key and receiver identification key.

The CTD format (i.e., abstract transaction) generally has a number of abstract elements as defined. In accordance with an example implementation, the CTD format is bound by the following concrete values: sender identification key, receiver identification key, unique transaction index value, and listener identification character value. These concrete values are particularly utilized by the present invention system 10 for organizing, managing, and moving data transactions. In accordance with an example implementation, the CTD format can further include metadata having at least one meta string and at least one meta value along with the sender identification key, receiver identification key, listener identification character value, and unique transaction index value. In one example, the general makeup of CTD transactions can include a string, character, and/or XML. This overall organization of the CTD format in terms of document architecture allows for the CTD format to function as a universal language. Other variations of components or elements can be included within CTD format as appreciated by one of skill in the art while staying within scope of the present invention.

At the transaction exchange server 12, movement of the data transaction is based on the concrete values (i.e., sender identification key, receiver identification key, unique transaction index value, and listener identification character value). Thus, the definition of various actions at the transaction exchange server 12 are based on these concrete data values, whereas the actions of the applications 32 are based on the abstract values in the data transaction and are only implemented when the data transaction is received and stored within the actual application 32 (e.g., asynchronously). Thus, these embedded values in the CTD format allow for an application 32 to view data transactions (e.g., messages) organized by the concrete values. Also, for example, the CTD format allows an application 32 to define a specific set of actions based on one or more of the concrete values (e.g., listener identification character value) and/or certain abstract values.

In one example, two listener identification character values (e.g., PurchaseOrders and SalesTransactions) are configured for a business. When the business receives and saves data transactions labeled with PurchaseOrders from the transaction exchange server 12, an asynchronous specific transformation routine occurs based on what is defined for PurchaseOrders. When the business receives and saves SalesTransactions from the transaction exchange server 12, it causes an asynchronous specific transformation routine to run based on what is defined for SalesTransactions. These actions may be processed and grouped by their unique transaction index value. Thus, the listener identification character values (i.e., ListenerIDs: PurchaseOrders and SalesTransactions) are directly related to a specific type of event (receiving data transaction) defined as having a correlating reaction (asynchronous specific transformation routine). Another example use could include a manufacturer and distributor arrangement. A distributor of electronic components needs an automated method of setting their sales price which depends on fluctuating manufacturer components. The Manufacturer (sender—source system 16) would send price changes to the transaction exchange server 12 and the distributors (receivers—destination systems 22) could monitor for new pricing changes and automatically update their sale price accordingly based on the present invention system 10.

By creating a CTD format (i.e., abstract transaction format) that every transaction in the world can conform to, the building of a message exchange system 10 is enabled where businesses and applications can share transaction data without having to manipulate the data structure in its purest form. The format of the CTD can be varied while staying within the scope of the present invention system 10. For example, a similar document format that inherently is created in an abstract way could be utilized to send messages. In particular, data in a CTD format (e.g., XML message) can be wrapped with an envelope which contains the sender and receiver identification key to be stored in the transaction exchange server 12. In this scenario, the receiver is accountable to manage the data (i.e., transaction) as needed. This is a significant step forward in terms of functionality even though this architecture is not equivalent to the architecture defined above.

Below is a structural representation of an example data transaction in an application-specific file format (e.g., typical concrete message) from an application 32:

<Invoice>

<Number>ORDER0001</Number>
<Amount>55.00</Amount>
<Customer>First Name</Customer>
<Type>INVOICE</Type>

</Invoice>

The above data transaction in the application-specific file format (e.g., concrete message) can be converted to a data transaction in a CTD format through the present invention system 10. Below is a structural representation of the transformed data transaction in CTD format:

<Message>

<ListenerID>GP.Invoices</ListenerID>
<Sender>COMPANYNAME.INC.000000004</Sender>
<Receiver>COMPANYNAME.LLC.000000005</Receiver>
<Created_by>Second Name</Created_by>
<Created_date>03/02/2014</Created_date>
<AuditID>ORDER0001</AuditID>
<Column_1>First Name</Column_1>
<Column_2>ORDER0001</Column_2>
<Column_3>INVOICE</Column_3>
<ColumnDecimal_1>55.00</ColumnDecimal_1>

</Message>
<Meta>

<ListenerID>GP.Invoices</ListenerID>
<ColumnMeta_1> Customer</ColumnMeta_1>
<ColumnMeta_2>Number</ColumnMeta_2>
<ColumnMeta_3>Type</ColumnMeta_3>
<ColumnDecimalMeta_1>Amount</ColumnDecimalMeta_1>

</Meta >

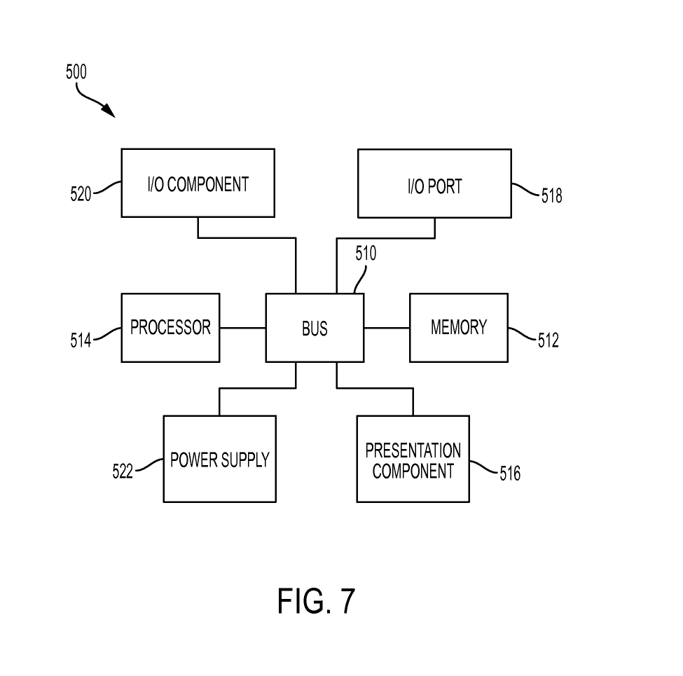

FIG. 7 illustrates an example of a computing device 500 which can provide computing or processing functionality for the system 10 and method for managing data transactions and any other processing functionality described herein and utilized in the implementation of aspects of the illustrative methods and systems of the present invention. The computing device 500 is merely an illustrative example of a suitable computing environment and in no way limits the scope of the present invention. A “computing device,” as represented by FIG. 7, can include a “workstation,” a “server,” a “laptop,” a “desktop,” a “hand-held device,” a “mobile device,” a “tablet computer,” or other computing devices, as would be understood by those of skill in the art. Given that the computing device 500 is depicted for illustrative purposes, embodiments of the present invention may utilize any number of computing devices 500 in any number of different ways to implement a single embodiment of the present invention. Accordingly, embodiments of the present invention are not limited to a single computing device 500, as would be appreciated by one with skill in the art, nor are they limited to a single type of implementation or configuration of the example computing device 500.

The computing device 500 can include a bus 510 that can be coupled to one or more of the following illustrative components, directly or indirectly: a memory 512, one or more processors 514, one or more presentation components 516, input/output ports 518, input/output components 520, and a power supply 522. One of skill in the art will appreciate that the bus 510 can include one or more busses, such as an address bus, a data bus, or any combination thereof. One of skill in the art additionally will appreciate that, depending on the intended applications and uses of a particular embodiment, multiple components can be implemented by a single device. Similarly, in some instances, a single component can be implemented by multiple devices. As such, FIG. 7 is merely illustrative of an exemplary computing device that can be used to implement one or more embodiments of the present invention, and in no way limits the invention.

The computing device 500 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 500.

The memory 512 can include computer-storage media in the form of volatile and/or nonvolatile memory. The memory 512 can be removable, non-removable, or any combination thereof. Exemplary hardware devices are devices such as hard drives, solid-state memory, optical-disc drives, and the like. The computing device 500 can include one or more processors 514 that read data from components such as the memory 512, the various I/O components 520, etc. Presentation component(s) 516 present data indications to a user or other device. Exemplary presentation components 516 include a display device, speaker, printing component, vibrating component, etc. The I/O ports 518 can allow the computing device 500 to be logically coupled to other devices, such as I/O components 520. Some of the I/O components 520 can be built into the computing device 500. Examples of such I/O components 520 include a microphone, joystick, recording device, game pad, satellite dish, scanner, printer, wireless device, Bluetooth® device, networking device, and the like.

One of skill in the art will appreciate a wide variety of ways to modify and alter the systems and method of FIGS. 1-5, as well as the various components with which it interacts. For example, the one or more computing systems can be implemented according to any number of suitable computing system structures. Furthermore, some or all of the information contained in the one or more data sources alternatively can be stored in one or more remote databases (e.g., cloud computing infrastructure such as cloud databases, virtual databases, and any other remote database).

In some embodiments, it may be desirable to implement the method and system using multiple iterations of the depicted modules, controllers, and/or other components, as would be appreciated by one of skill in the art. Furthermore, while some modules and components are depicted as included within the system, it should be understood that, in fact, any of the depicted modules alternatively can be excluded from the system and included in a different system. One of skill in the art will appreciate a variety of other ways to expand, reduce, or otherwise modify the system upon reading the present specification.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A system for managing data transactions, comprising:
a transaction exchange server;
a first listener modular program instance installed at a source system, the source system supporting an application utilizing a first application-specific file format; and
a second listener modular program instance installed at a destination system, the destination system supporting an application utilizing a second application-specific file format which is a different file format from the first application-specific file format;
wherein the first listener modular program instance transforms data supplied by, and stored at, the source system from the first application-specific file format, storable and readable by the application utilizing the first application-specific file format, into data in a common transaction description format, and communicates the data in the common transaction description format to the transaction exchange server, which stores the data in the common transaction description format as an active transaction until the destination system initiates a call to receive the data;
wherein the second listener modular program instance at the destination system initiates the call to receive the data;
wherein the transaction exchange server copies the data and communicates the copied data in the common transaction description format to the destination system;
wherein the second listener modular program instance at the destination system confirms receipt of the copied data and transforms the copied data from the common transaction description format into the second application-specific file format storable and readable by the application utilizing the second application-specific file format at the destination system; and
wherein the transaction exchange server stores the data as a historic transaction after the second listener modular program instance at the destination system confirms receipt of the copied data.

2. The system of claim 1, wherein the first listener modular program instance installed at the source system is authenticated to the transaction exchange server.

3. The system of claim 1, wherein the second listener modular program instance installed at the destination system is authenticated to the transaction exchange server.

4. The system of claim 1, wherein the first listener modular program instance utilizes Structured Query Language to transform the data supplied by, and stored at, the source system from the first application-specific file format into the data in the common transaction description format.

5. The system of claim 1, wherein the second listener modular program instance at the destination system utilizes Structured Query Language to transform the data in the common transaction description format into data in the second application-specific file format.

6. The system of claim 1, wherein the first application-specific file format and the second application-specific file format comprise proprietary formats, non-proprietary formats, open source formats, or open-standard formats.

7. The system of claim 1, wherein the first application-specific file format and the second application-specific file format comprise text file formats, graphic file formats, data file formats, spreadsheet file formats, word processor file formats, video and audio file formats, markup language formats, archive formats, compressed formats, computer-aided formats, database formats, webpage formats, mobile device formats, windows file formats, or object file formats.

8. The system of claim 1, wherein the first listener modular program instance and the second listener modular program instance comprise an interpretation layer which builds an integration infrastructure based on a unique definition of an interface of the application utilizing either the first application-specific file format or the second application-specific file format.

9. The system of claim 1, wherein the common transaction description format further comprises a listener identification character value corresponding with either the first listener modular program instance or the second listener modular program instance.

10. The system of claim 1, wherein the common transaction description format further comprises a unique transaction index value corresponding with either the first application-specific file format or the second application-specific file format.

11. The system of claim 1, wherein the common transaction description format further comprises a sender identification key corresponding with the application utilizing the first application-specific file format.

12. The system of claim 1, wherein the common transaction description format further comprises a receiver identification key corresponding with the application utilizing the second application-specific file format.

13. The system of claim 1, wherein the common transaction description format further comprises metadata having at least one meta string and at least one meta value.

14. A computer-implemented method of communicating data transactions between applications, the method comprising:
an application of a source system supplying data in a first application-specific file format;
a first listener modular program instance of a source system transforming the data, supplied by the source system, from the first application-specific file format into data in a common transaction description format;
the first listener modular program instance communicating the data in the common transaction description format to a transaction exchange server;
the transaction exchange server storing the data in the common transaction description format as an active transaction until a destination system initiates a call to receive the data;
a second listener modular program instance at the destination system initiating a call to the transaction exchange server to receive the data;
the transaction exchange server communicating the data to the second listener modular program instance at the destination system in the common transaction description format; and
the second listener modular program instance at the destination system receiving the data in the common transaction description format from the transaction exchange server, wherein an application of the destination system utilizes a second application-specific file format which is a different file format from the first application-specific file format.

15. The method of claim 14, further comprising the transaction exchange server storing the data as a historic transaction after the second listener modular program instance at the destination system confirms receipt of the data.

16. A computer-implemented method of communicating data transactions between applications, the method comprising:
a transaction exchange server receiving data in a common transaction description format from a source system;
the transaction exchange server storing the data in the common transaction description format as an active transaction until a destination system initiates a call to receive the data;
the transaction exchange server receiving a call from a listener modular program instance at the destination system to receive the data;
the transaction exchange server communicating the data in the common transaction description format to the destination system; and
receiving confirmation from the listener modular program instance of the destination system that the data in the common transaction description format was received from the transaction exchange server.

17. The method of claim 16, further comprising the transaction exchange server storing the data as a historic transaction after the listener modular program instance at the destination system confirms receipt of the data.

18. A listener system providing universal communication to an application, the listener system comprising:
a sending module configured to direct data in a common transaction description format from an application to a transaction exchange server;
a receiving module configured to obtain data in the common transaction description format from the transaction exchange server; and
a transformation module configured to transform data from at least one application-specific file format into data in the common transaction description format and transform data from the common transaction description format into the at least one application-specific file format, wherein the at least one application-specific file format is storable and readable by the application.

19. The listener system of claim 18, further comprising a posting module configured to incorporate new data in the at least one application-specific file format with previously stored data in the at least one application-specific file at the application.
